(19) United States
(12) Patent Application Publication
(10) Pub. No.: US 2009/0057597 A1
(43) Pub. Date: Mar. 5, 2009

(54) PROTECTION VACUUM GATE VALVE

(76) Inventor: Jong-Woo Ji, Suwon City (KR)

Correspondence Address: IPLA P.A., 3580 WILSHIRE BLVD., 17TH FLOOR, LOS ANGELES, CA, 90010, US

(21) Appl. No.: 11/577,986

(22) PCT Filed: Dec. 27, 2006
(86) PCT No.: PCT/KR2006/005728

§ 371 Date: Apr. 25, 2007

(30) Foreign Application Priority Data
Feb. 1, 2006 (KR) 10-2006-0009691

(51) Int. Cl. F16K 25/04; F16K 3/30

(52) U.S. Cl. 251/328; 251/118

(57) ABSTRACT

The present invention relates to an improved vacuum gate valve for a corrosion prevention. The corrosion prevention vacuum gate valve comprises a second actuator which includes a hollow first body which has a second compression air inlet for moving up the corrosion prevention sealing member and a hollow second body which has a third compression air inlet moving down the corrosion prevention sealing member and at least one flow control groove which is provided at the upper side for moving the fluid from the chamber to the vacuum pump.

### CROSS REFERENCES

Applicant claims priority under Patent Cooperation Treaty and 35 U.S.C. § 371 to International Application No. PCT/KR2006/005728 filed Dec. 27, 2006 which claims foreign priority under Paris Convention to Korean Patent Application No. 10-2006-0009691, filed Feb. 1, 2006 with the Korean Intellectual Property Office.

### TECHNICAL FIELD

The present invention relates to an improved vacuum gate valve for a corrosion prevention, and in particular to an improved vacuum gate valve for a corrosion prevention in which it is possible to prevent a corrosion of a fluid passage sealing member as fluid is inputted into a slide space by providing a flow control groove at a portion contacting with a slide space at both upper sides of a second body, and it is possible to control the flow without forming an auxiliary fluid tube when fluid flows from a chamber to a vacuum pump.

### BACKGROUND ART

Generally, a semiconductor requires a high accuracy, so that a reliable cleanness and special manufacture technology are needed. For these reasons, a semiconductor device is manufactured in a vacuum state in which a contact with foreign substance contained in the air can be substantially prevented. So, a vacuum work section of a semiconductor manufacture equipment and a sealing technology with respect to the air are largely depended on the quality of a semiconductor product.

A vacuum valve is an important element. The vacuum valve is installed between a chamber, in which an integration process of a semiconductor device is performed, and a vacuum pump for pumping the air of the chamber so that a suction force of the vacuum pump is transferred to the chamber and opening and closing the above operation. In addition, it is an important matter to elongate the life span of the vacuum valve.

A conventional vacuum gate valve will be described with reference to FIGS. 1 and 2.

FIG. 1 is a view of a construction of a conventional flow control vacuum gate valve, which is disclosed in a flow control valve of the Korean registration patent gazette No. 10-0520726 registered by the applicant of the present invention.

As shown in FIG. 1, a conventional flow control vacuum gate valve comprises a body 10. The body 10 comprises an inlet part 12 for inputting fluid, an outlet part 14 for discharging fluid, a main fluid passage 111 connecting the inlet and outlet parts 12 and 14, a straight auxiliary fluid tube 16 which is outwardly installed from a side of the inlet part 12 for flowing a slight amount of fluid, a straight auxiliary tube 17 for discharging the fluid from the auxiliary fluid tube 16 to the outlet part 14, and a connection type plate having a slide space 13. The body further comprises a sealing member (not shown) for opening and closing the main fluid passage 11, a main actuator (not shown) for driving a first driving shaft (not shown) connected with the sealing member, and a tube diameter control member for controlling the diameter of one between the auxiliary fluid tube 16 and the auxiliary fluid tube 17.

However, when fluid is inputted into the main fluid passage 11 as the conventional vacuum gate valve is open, it is needed to install the auxiliary fluid tube 16 and the auxiliary fluid tube 17 so as to control the flow of fluid which moves from the chamber to the vacuum pump, the manufacture process of the valve and the cost are increased.

In addition, it is needed to additionally provide a tube diameter control valve 70 so as to control the diameter of the auxiliary fluid tube 17, so that the whole construction is complicated.

When the fluid moves from the chamber to the vacuum pump, the fluid is inputted into the slide space 13, so that powder is attached in the slide space 13, whereby the operation of the sealing member, which opens and closes the main fluid passage 11, may stop or the sealing member may be corroded.

So as to overcome the above problems, as shown in FIG. 2, the vacuum gate valve is provided.

As shown in FIG. 2, the conventional vacuum gate valve for a corrosion prevention comprises a housing 10 having a main fluid passage 11 connected between a chamber (not shown) and a vacuum pump (not shown) and a slide space 13 passing through the main fluid passage 111 in a perpendicular direction, a fluid passage sealing member 20 which is inserted in the slide space 13 and opens and closes the main fluid passage 11, a first actuator 40 which forwardly and backwardly drives a driving shaft 41 connecting the fluid passage sealing member 20 and the link 30, a corrosion sealing member 50 which vertically moves in the direction parallel with the main fluid passage 11 and opens and closes the slide space 13, and a second actuator 60 which upwardly and downwardly drives the corrosion prevention sealing member 50.

However, the conventional vacuum gate valve is able to prevent the fluid from being inputted the slide space 13 by providing the corrosion prevention sealing member 50. When the valve is abruptly opened, the valve may be damaged owing to the pressure difference between the chamber and the vacuum pump. So as to prevent the damage of the valve, an auxiliary fluid passage 12 is additionally needed so as to prevent the damage of the valve, and a certain member is further additionally needed so as to control the flow toward the auxiliary fluid passage 12.

### DISCLOSURE

### Technical Problem

Accordingly, it is an object of the present invention to overcome the above problems.

It is another object of the present invention to provide a vacuum gate valve for a corrosion prevention in which it is possible to prevent a corrosion of a fluid passage sealing member as fluid is inputted into a slide space by providing a flow control groove at a portion contacting with a slide space at both upper sides of a second body, and it is possible to control the flow without forming an auxiliary fluid tube when fluid flows from a chamber to a vacuum pump.

It is further another object of the present invention to provide a vacuum gate valve for a corrosion prevention in which a sealing plate is made thinner and simpler, so that the cost can decrease.

It is still further another object of the present invention to provide a vacuum gate valve for a corrosion prevention in which an elastic part is provided at an upper side of a sealing plate, and a main fluid passage is opened and closed when a sealing plate is moved as a corrosion prevention sealing member is upwardly and downwardly moved,

It is still further another object of the present invention to provide a vacuum gate valve for a corrosion prevention in which a sealing property can be enhanced by forming an O-ring in the interior of a housing contacting with an upper side of a corrosion prevention sealing member.

### Technical Solution

To achieve the above objects, in a vacuum gate valve which includes a housing having a main fluid passage connected with a chamber and a vacuum pump and a slide space passing through the main fluid passage in a perpendicular direction; a fluid passage sealing member which is inserted into the slide space and opens and closes the main fluid passage; a first actuator which drives the fluid passage sealing member; a corrosion prevention sealing member which moves vertically in parallel with the main fluid passage and opens and closes the slide space; and a second actuator which moves the corrosion prevention sealing member is up and down directions, there is provided a corrosion prevention vacuum gate valve which comprises a second actuator which includes a hollow first body which has a second compression air inlet for moving up the corrosion prevention sealing member; and a hollow second body which has a third compression air inlet moving down the corrosion prevention sealing member and at least one flow control groove which is provided at the upper side for moving the fluid from the chamber to the vacuum pump.

The fluid passage sealing member comprises a frame which is linked with a driving shaft of the first actuator and moves in the slide space; a sealing plate which is engaged at an upper side of the frame and moves along with the same in the slide space and moves up and down in the main fluid passage for thereby opening and closing the main fluid passage; and at least two fixtures which fixes the sealing plate to the frame.

The fluid passage sealing member comprises an elastic member which is positioned between the sealing plate and the fixture and provides force to the sealing plate in a downward direction.

An O-ring is provided at a portion contacting with an upper side of the corrosion prevention sealing member in the interior of the housing.

There are further provided a first protrusion which is formed at a center of the corrosion prevention sealing member like surrounding an outer surface, and a guide groove which guides a movement of the first protrusion formed at the corrosion prevention sealing member.

The first actuator comprises a sensor which detects the position of the fluid passage sealing member and a display means for displaying the values of the sensor which detects the position of the corrosion prevention sealing member.

### ADVANTAGEOUS EFFECTS

As described above, according to the present invention, a flow control groove is formed at a portion contacting with a slide space at both upper sides of a second body, so that it is possible to prevent a corrosion of a fluid passage sealing member as fluid is inputted into a slide space. It is possible to control the flow when fluid flows from a chamber to a vacuum pump without forming an auxiliary fluid tube.

In addition, a sealing plate is made thinner and simpler, so that a manufacturing work is easy, and the cost decreases.

An elastic part is provided at an upper side of the sealing plate, so that it is possible to open and close a main fluid passage when a sealing plate moves as a corrosion prevention sealing member moves up and down.

### DESCRIPTION OF DRAWINGS

FIG. 1 is a view of a construction of a conventional flow control vacuum gate valve.

FIG. 2 is a side view of a conventional corrosion prevention vacuum gate valve.

FIG. 3 is a side view of a state when a fluid passage sealing member of a corrosion prevention vacuum gate valve is open according to an embodiment of the present invention.

FIG. 4 is a side view of a state when a fluid passage sealing member of a corrosion prevention vacuum gate valve is closed according to an embodiment of the present invention.

FIG. 5 is a view of a construction of a fluid passage sealing member according to the present invention.

FIG. 6 is a perspective view illustrating a construction of a second body according to the present invention.

FIG. 7 is a disassembled cross sectional view of a construction of a corrosion prevention sealing member and a second actuator according to the present invention.

FIG. 8 is a view of a procedure when a corrosion prevention vacuum gate valve is open according to the present invention.

FIG. 9 is a view of a procedure when a corrosion prevention vacuum gate valve is closed according to the present invention.

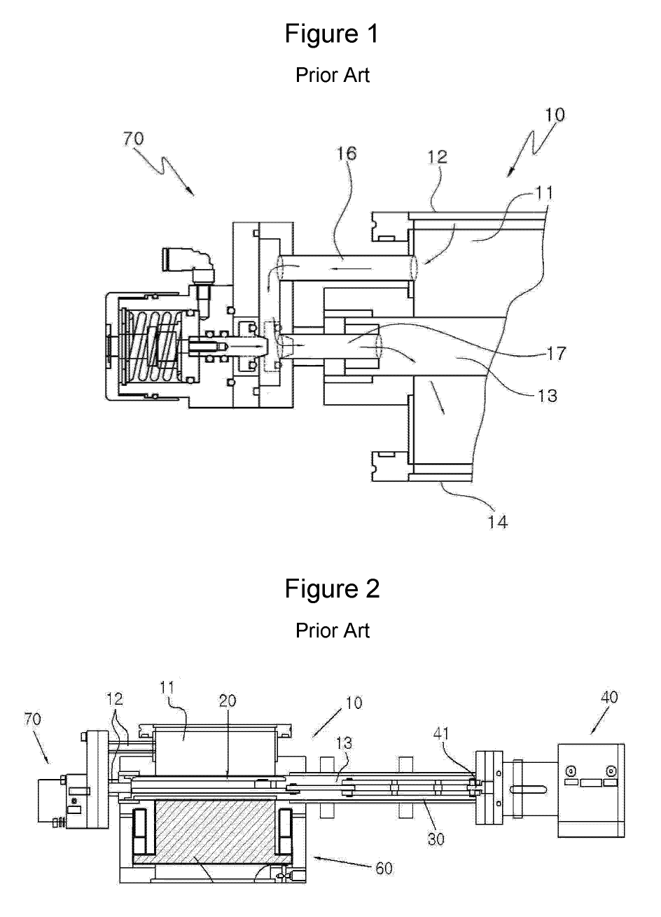

### BEST MODE

In a vacuum gate valve which includes a housing having a main fluid passage connected with a chamber and a vacuum pump and a slide space passing through the main fluid passage in a perpendicular direction; a fluid passage sealing member which is inserted into the slide space and opens and closes the main fluid passage; a first actuator which drives the fluid passage sealing member; a corrosion prevention sealing member which moves vertically in parallel with the main fluid passage and opens and closes the slide space; and a second actuator which moves the corrosion prevention sealing member is up and down directions, there is provided a corrosion prevention vacuum gate valve which comprises a second actuator which includes a hollow first body which has a second compression air inlet for moving up the corrosion prevention sealing member; and a hollow second body which has a third compression air inlet moving down the corrosion prevention sealing member and at least one flow control groove which is provided at the upper side for moving the fluid from the chamber to the vacuum pump.

### MODE FOR INVENTION

The present invention will be described with reference to the accompanying drawings. The same reference numerals of the drawings represent the same elements.

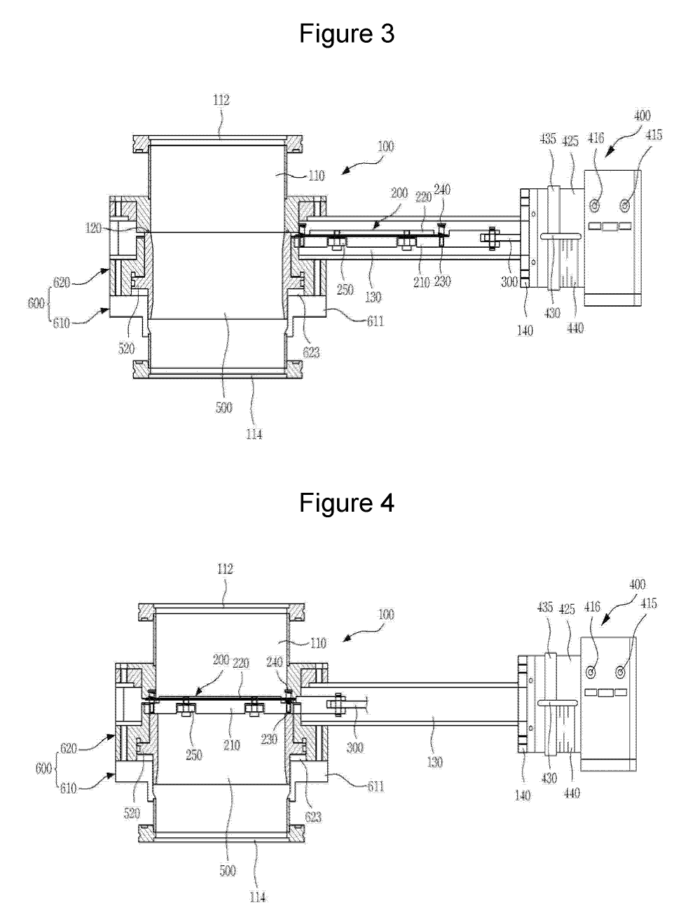

FIG. 3 is a side view of a state when a fluid passage sealing member of a corrosion prevention vacuum gate valve is open according to an embodiment of the present invention. FIG. 4 is a side view of a state when a fluid passage sealing member of a corrosion prevention vacuum gate valve is closed according to an embodiment of the present invention.

As shown in FIGS. 3 and 4, the corrosion prevention vacuum gate valve according to a preferred embodiment of the present invention comprises a housing 100, a fluid passage sealing member 200, a link 300, a first actuator 400, a corrosion prevention sealing member 500 and a second actuator 600.

The housing 100 comprises a main fluid passage 110, and a slide space 130.

The main fluid passage 110 comprises an inlet 112 formed at its one side and connected with a chamber, and an outlet 114 formed at its other side and connected with a vacuum pump. The main fluid passage 110 is a passage for guiding the fluid from the chamber to the vacuum pump.

The slide space 130 passes through the main fluid passage 110 in a perpendicular direction. A fluid passage sealing member 200, which will be described later, moves along the slide space 130. A fluid passage sealing member 200, which will be described later, moves along the slide space 130 and opens and closes the main fluid passage 110.

An O-ring 120 is preferably installed in the interior of the housing 100 at a portion contacting with an upper side of the corrosion prevention sealing member 500 when the corrosion prevention sealing member 500 moves up and closes the slide space 130.

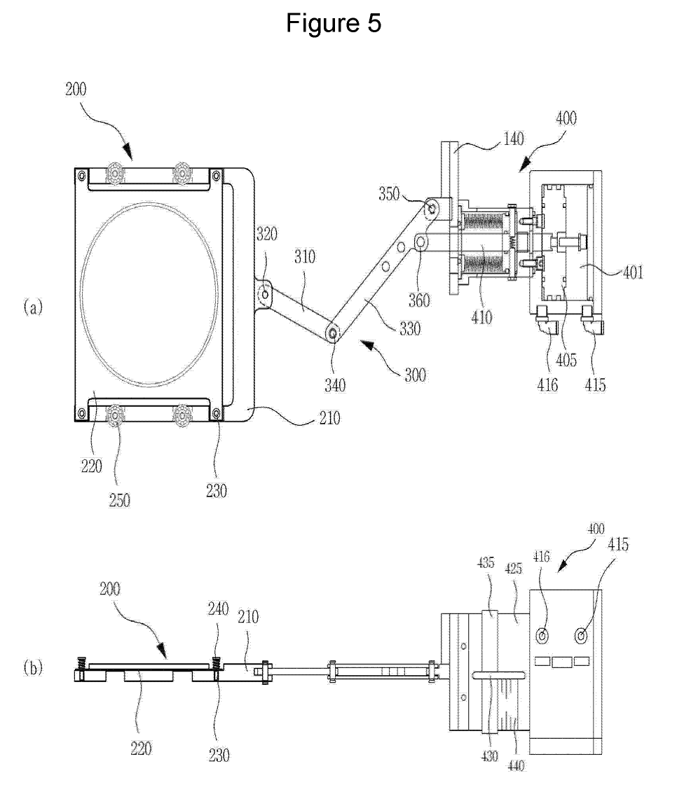

As shown in FIG. 5, the fluid passage sealing member 200 moves along the slide space 130 and is made of a thin plate which opens and closes the main fluid passage 110 and comprises a frame 210, a sealing plate 220, and a fixture 230.

The frame 210 is linked to a driving shaft 410 of a first actuator 400, which will be described later, and moves along the slide space 130. A sealing plate 220 is engaged at an upper side of the same and moves along the slide space 130 along with the sealing plate 220. When it is positioned at the main fluid passage 110, it preferably supports so that the sealing plate 220 moves up and down.

The sealing plate 220 is engaged at an upper side of the frame 210 and is made of a thin plate which moves along the slide space 130. In the present invention, when the fluid passage sealing member 200 is positioned at the main fluid passage 110, the sealing plate 220 moves up and down based on the up and down operations of the corrosion prevention sealing member 500, so that the main fluid passage 110 is opened and closed.

The fixture 230 is provided for fixing the sealing plate 220 to the frame 210. When the sealing plate 220 is rectangular, it is provided by four. Two fixtures may be diagonally provided.

The fluid passage sealing member 20 is provided between the sealing plate 220 and the fixture 230 and is preferably provided with the elastic member 240 which provided a downward force to the sealing plate 220.

The elastic member 240 is engaged at an upper side of the sealing plate 220 by the fixture 230. When the valve is open, the sealing plate 220 is fixed at the frame 210, so that it does not move. As the valve is closed, when the fluid passage sealing member 200 is positioned at the main fluid passage 110, it is applied with a pressure from the sealing plate 220 based on the up move of the corrosion prevention sealing member 500.

When the corrosion prevention sealing member 500 moves down, the elastic member 240, which is contracted by the move of the sealing plate 220, is released for thereby allowing the sealing plate 220 to move down. The slide space 130 opens by a certain gap, so that it is possible to control the pressure of fluid which moves from the chamber to the vacuum pump through the flow control groove 625.

A plurality of rollers 250 contacting with a side wall of the slide space 130 are rotatably engaged at the edge of the frame 210. The fluid passage sealing member 200 can easily move in the slide space 130 with the help of the rollers 250 provided at the frame 210.

As shown in FIG. 5, the link 300 comprises a first shaft 310 and a second shaft 330. One end of the first shaft 310 is rotatably engaged at the frame 210 with the help of a first hinge shaft 210. The other end of the first shaft 310 and one end of the second shaft 330 are rotatably connected with the help of a second hinge shaft 340. The other end of the second shaft 330 is rotatably connected with a disconnection plate 140 with the help of a third hinge shaft 350 and is rotatably connected with the driving shaft 410 with the help of a fourth hinge shaft 360. As the driving shaft 410 moves forward, the link 300 allows the second shaft 330 and the first shaft 310 to rotate, so that the force is applied in the direction that the first shaft 310 moves forward, so that the frame 210 moves forward. On the contrary, when the driving shaft 410 moves backward, the second shaft 330 and the first shaft 310 rotate in reverse direction, and the force is applied in the direction that the first shaft 310 moves backward, so that the frame 210 moves backward.

The first actuator 400 allows the driving shaft 410 to move forward and backward. The first actuator 400 may be designed in an automatic type or a manual type. In the case of the automatic type, it is preferably formed of a pneumatic type which operates based on a compression air.

The pneumatic type first actuator 400 comprises first compression air inlets 415 and 416 for receiving compression air, a first cylinder 405, a driving shaft 410, etc. Since it is a known element, the detailed description will be omitted.

As shown in FIG. 5, the first actuator 400 comprises an indication ring 435 so that it is possible to easily check the operation of the first actuator 400 from the outside, and a fixing cylindrical member 425 having a slide groove 430 along its outer surface.

The indication ring 435 is engaged with the driving shaft 410 in distance from the outer surface of the fixing cylindrical member 425. When the driving shaft 410 moves, it operates along the slide groove 430. A ruler 440 is attached on an outer surface of the fixing cylindrical member 425 for indicating the opening and closing operations of the valve. The indication ring 435 is preferably made of a transparent material so that the contents indicated on the ruler 440 can be easily recognized.

The first actuator 400 is preferably provided with a sensor (not shown) for thereby easily detecting the position of the fluid passage sealing member 200. The sensor detects the position of the fluid passage sealing member 200, so that the corrosion prevention sealing member 500 properly operates.

The corrosion prevention sealing member 500 moves vertically for thereby opening and closing the slide space 130 formed in the main fluid passage 110. It may be formed in various shapes. More simply, it may be formed in a cylinder type which surrounds the main fluid passage 110 formed in the housing 100.

The corrosion prevention sealing member 500 has a first protrusion 520 at its center portion.

The first protrusion 520 is formed at a center portion of the corrosion prevention sealing member 500 like surrounding an outer surface. When air is inputted through a second compression air inlet 612 and a third compression air inlet 622, it is provided with pressure for thereby allowing the corrosion prevention sealing member 500 to move up and down.

The corrosion prevention sealing member 500 moves up and down by the second compression air inlet 612 formed at the first body 610 and the third compression air inlet 622 formed at the second body 620.

The corrosion prevention sealing member 500 may move down as the air is inputted from the third compression air inlet 622. When force is not externally provided, namely, when the air is not inputted from the second compression air inlet 612, it may naturally drop down by its self weight. So, the third compression air inlet 622 may not be a necessary element.

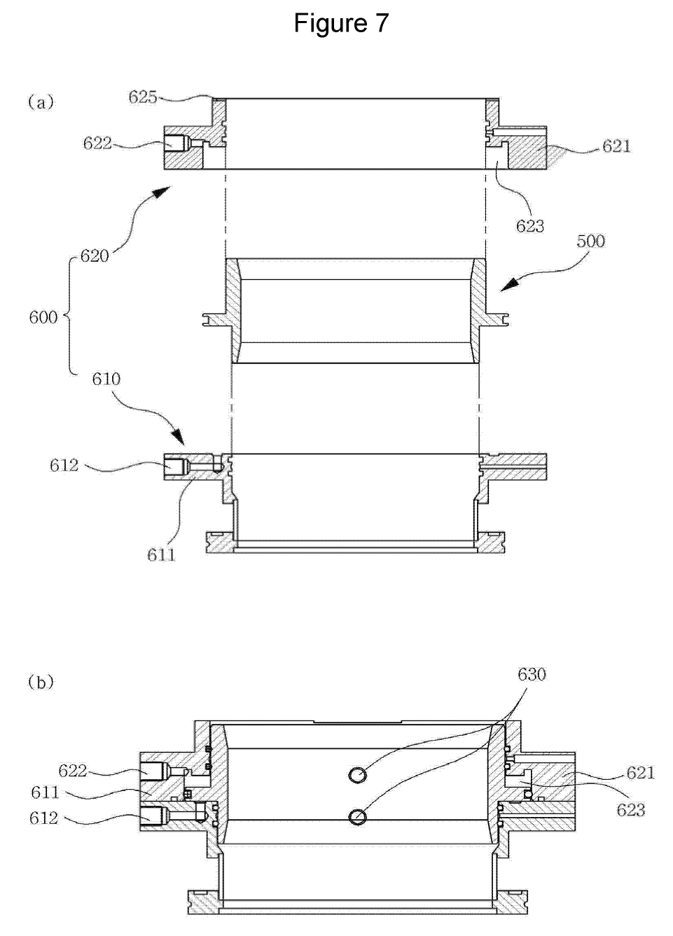

The construction and operation of the second actuator will be described with reference to FIG. 7.

The second actuator 600 comprises a first body 610 and a second body 620.

The first body 610 comprises a second protrusion 611 along an upper outer side so that it is engaged with the second body 620. A second compression air inlet 612 is formed at an inner side of the second protrusion 611.

The second compression air inlet 612 is formed at a lower side of the first protrusion 520 of the corrosion prevention sealing member 500. When compression air is inputted through the second compression air inlet 612, the pressure is applied to the first protrusion 520 positioned above the same, so that the corrosion sealing member 500 moves up.

The second body 620 is engaged with the first body 610 with respect to the corrosion prevention member 500. A third protrusion 621 is formed along an outer lower side so that it is engaged with the first body 610. A third compression air inlet 622 is formed at an inner side of the third protrusion 621.

The third compression air inlet 622 is formed at both upper sides of the first protrusion 520 of the corrosion prevention sealing member 500. When compression air is inputted through the third compression air inlet 622, the pressure is applied to the first protrusion 520 positioned below the same, so that the corrosion prevention sealing member 500 moves down.

A guide groove 623 is formed along an inner side of the second body 620 for guiding the up and down moves of the first protrusion 520 of the corrosion prevention sealing member 500.

In the present invention, the second body 620 has a flow control groove 625 at a portion contacting with the slide space 130 at both upper side of the same. When fluid moves from the chamber to the vacuum pump, it is possible to control the flow of fluid moving through the main fluid passage 110 with the help of the flow control groove 625.

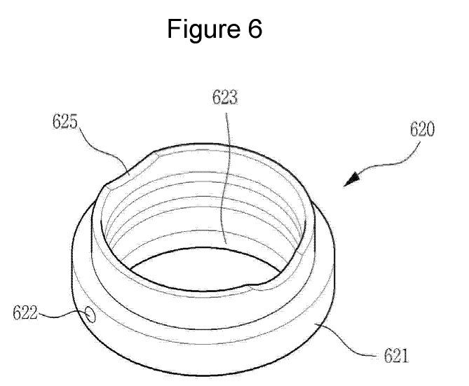

As shown in FIGS. 6 and 7, the flow control groove 625 is an elliptical groove formed from the upper side to the lower side of the second body 620. When the main fluid passage 110 is opened from the closed state, the fluid passage sealing member 200 moves down, and the slide space 130 opens by a certain gap. At this time, the fluid inputted from the chamber is inputted through the gap of the slide space 130. Part of the fluid moves in the direction of the vacuum pump through the flow control groove 625 formed in the second body 620. So, it is possible to prevent the damages of the process chamber and the vacuum pump which occur due to the pressure when the valve is abruptly opened.

The second body 620 has the flow control groove 625. When the valve is manufactured, it is possible to overcome inconveniences that the conventional auxiliary fluid passage and tube diameter control value are needed.

The second actuator 600 is provided with a fast exhaust valve 630 so that the corrosion prevention sealing member 500 can fast move. When the corrosion prevention sealing member 500 moves down owing to the fast exhaust valve 630, the fluid is forced to fast discharge into the second actuator 600, so that the corrosion prevention sealing member 500 can be fast moved.

The second actuator 600 is preferably provided with a sensor (not shown) which is able to detect the position of the corrosion prevention sealing member 500. When the sensor detects the position of the corrosion prevention sealing member 500, it is possible to control the operation of the fluid passage sealing member 200 with the detected values. The first actuator 400 is provided with a sensor which is able to detect the position of the fluid passage sealing member 200. The corrosion prevention sealing member 500 is driven depending on the position of the fluid passage sealing member 200.

The operation of the corrosion prevention vacuum gate valve according to the present invention will be described.

The procedure that the improved corrosion prevention vacuum gate valve opens will be described.

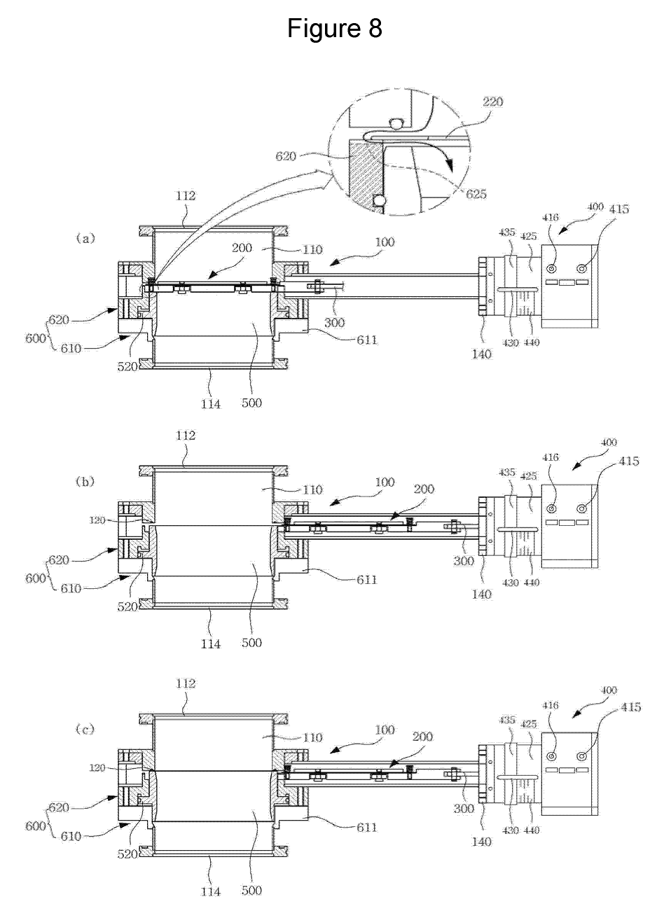

The procedure that the corrosion prevention vacuum gate valve opens will be described with reference to FIG. 8. In the closed state, the fluid passage sealing member 200 is positioned at the main fluid passage 110, and the corrosion prevention sealing member 500 pressurizes the fluid passage sealing member 200. At this time, when the compression air is inputted through the third compression air inlet 622, the corrosion prevention sealing member 500 moves down. Along with the down move of the corrosion prevention sealing member 500, the fluid passage sealing member 200 moves down. So, the slide space opens by a certain gap. Small amount of the fluid moves through the flow control groove 625 formed in the second body 620, so that it is possible to control the pressure of the vacuum pump from the chamber.

When the compression air is inputted through the first compression air inlet 416, and the driving shaft 410 of the first actuator 400 is ejected from the slide space 130 to the outside, the fluid passage sealing member 200 linked with the driving shaft 410 moves toward the first actuator 400. So, the fluid passage sealing member 200 is escaped from the main fluid passage 110 and is moved into the slide space 130 of the first actuator 400. When the fluid passage sealing member 200 is fully escaped from the main fluid passage 110, the motion of the driving shaft 410 of the first actuator 400 is detected by the sensor, and the compression air is inputted into the second compression air inlet 612. The inputted compression air applies pressure to the first protrusion 520, so that the corrosion prevention sealing member 500 moves up. The main fluid passage 110 is opened in a state that the slide space 130 is closed.

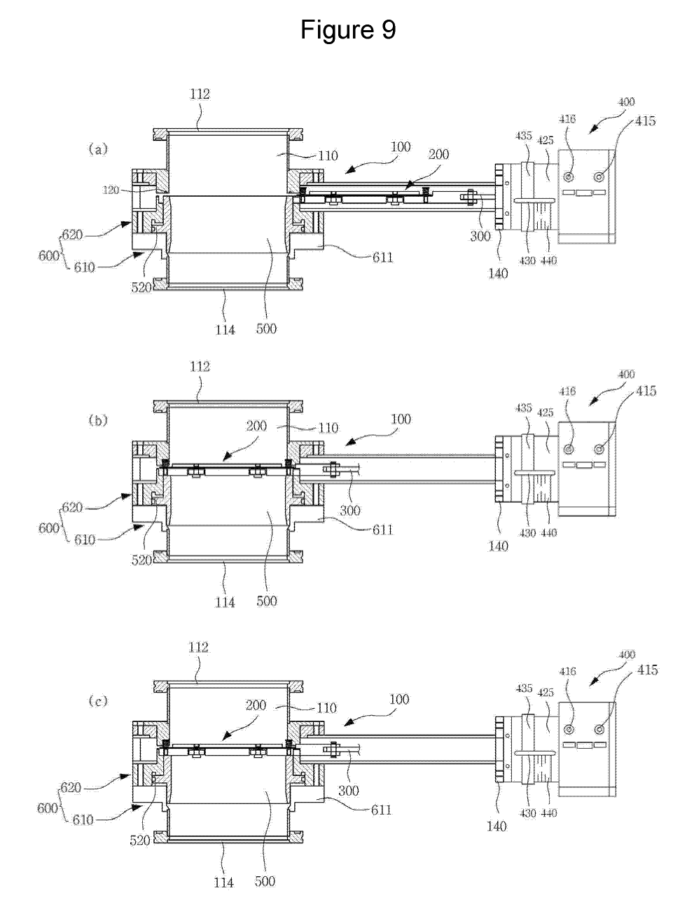

The procedure that the improved corrosion prevention vacuum gate valve will be described with reference to FIG. 9. In the open state, the fluid passage sealing member 200 is escaped from the main fluid passage 110 and is positioned at the slide space 130 in the direction of the first actuator 400. The corrosion prevention sealing member 500 moves up and closes the slide space 130. At this time, when the compression air is inputted through the third compression air inlet 622, the corrosion prevention sealing member 500 moves down, so that the slide space 130 is opened. When the motion of the corrosion prevention sealing member 500 is detected by the sensor, the compression air is inputted through the first compression air inlet 415 and allows the driving shaft 410 of the first actuator 400 to move toward the slide space 130. When the driving shaft 410 is pushed, the fluid passage sealing member 200 linked with the driving shaft 410 moves toward the main fluid passage 110, so that the main fluid passage 110 is closed. At this time, whereas the main fluid passage 110 is closed, since the slide space 130 is open, the compression air is inputted into the second compression air inlet 612 so as to prevent the fluid from being inputted into the slide space 130. The inputted compression air applies pressure to the first protrusion 520 provided above the same, so that the corrosion prevention sealing member 500 moves up. So, the corrosion prevention sealing member 500 closes the slide space, and at the same time, the fluid passage sealing member is pressurized, so that the main fluid passage 110 is sealed. As a result, the main fluid passage 110 is closed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

As described above, according to the present invention, a flow control groove is formed at a portion contacting with a slide space at both upper sides of a second body, so that it is possible to prevent a corrosion of a fluid passage sealing member as fluid is inputted into a slide space. It is possible to control the flow when fluid flows from a chamber to a vacuum pump without forming an auxiliary fluid tube.

In addition, a sealing plate is made thinner and simpler, so that a manufacturing work is easy, and the cost decreases.

An elastic part is provided at an upper side of the sealing plate, so that it is possible to open and close a main fluid passage when a sealing plate moves as a corrosion prevention sealing member moves up and down.

What is claims is:

1. In a vacuum gate valve which includes a housing having a main fluid passage connected with a chamber and a vacuum pump and a slide space passing through the main fluid passage in a perpendicular direction; a fluid passage sealing member which is inserted into the slide space and opens and closes the main fluid passage; a first actuator which drives the fluid passage sealing member; a corrosion prevention sealing member which moves vertically in parallel with the main fluid passage and opens and closes the slide space; and a second actuator which moves the corrosion prevention sealing member is up and down directions, a corrosion prevention vacuum gate valve, comprising:
said second actuator which includes:
a hollow first body which has a second compression air inlet for moving up the corrosion prevention sealing member; and
a hollow second body which has a third compression air inlet moving down the corrosion prevention sealing member and at least one flow control groove which is provided at the upper side for moving the fluid from the chamber to the vacuum pump.

2. The valve of claim 1, wherein said fluid passage sealing member comprises:
a frame which is linked with a driving shaft of the first actuator and moves in the slide space;
a sealing plate which is engaged at an upper side of the frame and moves along with the same in the slide space and moves up and down in the main fluid passage for thereby opening and closing the main fluid passage; and
at least two fixtures which fixes the sealing plate to the frame.

3. The valve of claim 2, wherein said fluid passage sealing member comprises an elastic member which is positioned between the sealing plate and the fixture and provides force to the sealing plate in a downward direction.

4. The valve of claim 1, wherein an O-ring is provided at a portion contacting with an upper side of the corrosion prevention sealing member in the interior of the housing.

5. The valve of claim 1, further comprising a first protrusion which is formed at a center of the corrosion prevention sealing member like surrounding an outer surface, and a guide groove which guides a movement of the first protrusion formed at the corrosion prevention sealing member.

6. The valve of claim 1, wherein said first actuator comprises a sensor which detects the position of the fluid passage sealing member and a display means for displaying the values of the sensor which detects the position of the corrosion prevention sealing member.

7. The valve of claim 1, wherein said second actuator comprises a fast exhaust valve for discharging the fluid of the second actuator to the outside.
